(19) United States
(12) Patent Application Publication
(10) Pub. No.: US 2007/0139421 A1
(43) Pub. Date: Jun. 21, 2007

(54) Methods and systems for performance monitoring in a graphics processing unit

(76) Inventors: Wen Chen, Cupertino, CA (US); John Brothers, Calistoga, CA (US); Guofang Jiao, San Jose, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/314,184

(22) Filed: Dec. 21, 2005

(51) Int. Cl. G06T 1/00

(52) U.S. Cl. 345/501

(57) ABSTRACT

Provided is a system for monitoring the performance in a computer graphics processor having a plurality of pipeline processing blocks in a graphics pipeline. The system includes: performance monitoring logic, configured to gather data corresponding to graphics pipeline performance; a plurality of counting logic blocks, located within the performance monitoring logic; a plurality of logical counters, located in each of the plurality of pipeline processing blocks, configured to transmit a plurality of count signals to the performance monitoring logic; a plurality of counter configuration registers, configured to map a portion of the plurality of logical counters to the plurality of counting logic blocks; and a command processor configured to provide a plurality of commands to the performance monitoring logic.

### TECHNICAL FIELD

The present disclosure is generally related to computer processing and, more particularly, is related to methods and apparatus for performance monitoring in a graphics processing unit.

### BACKGROUND

As is known, the art and science of three-dimensional (“3-D”) computer graphics concerns the generation, or rendering, of two-dimensional (“2-D”) images of 3-D objects for display or presentation onto a display device or monitor, such as a Cathode Ray Tube (CRT) or a Liquid Crystal Display (LCD). The object may be a simple geometry primitive such as a point, a line segment, a triangle, or a polygon. More complex objects can be rendered onto a display device by representing the objects with a series of connected planar polygons, such as, for example, by representing the objects as a series of connected planar triangles. All geometry primitives may eventually be described in terms of one vertex or a set of vertices, for example, coordinate (X, Y, Z) that defines a point, for example, the endpoint of a line segment, or a corner of a polygon.

To generate a data set for display as a 2-D projection representative of a 3-D primitive onto a computer monitor or other display device, the vertices of the primitive are processed through a series of operations, or processing stages in a graphics-rendering pipeline. A generic pipeline is merely a series of cascading processing units, or stages, wherein the output from a prior stage serves as the input for a subsequent stage. In the context of a graphics processor, these stages include, for example, per-vertex operations, primitive assembly operations, pixel operations, texture assembly operations, rasterization operations, and fragment operations.

In a typical graphics display system, an image database (e.g., a command list) may store a description of the objects in the scene. The objects are described with a number of small polygons, which cover the surface of the object in the same manner that a number of small tiles can cover a wall or other surface. Each polygon is described as a list of vertex coordinates (X, Y, Z in “Model” coordinates) and some specification of material surface properties (i.e., color, texture, shininess, etc.), as well as possibly the normal vectors to the surface at each vertex. For 3-D objects with complex curved surfaces, the polygons in general must be triangles or quadrilaterals, and the latter can always be decomposed into pairs of triangles.

A transformation engine transforms the object coordinates in response to the angle of viewing selected by a user from user input. In addition, the user may specify the field of view, the size of the image to be produced, and the back end of the viewing volume to include or eliminate background as desired.

Once this viewing area has been selected, clipping logic eliminates the polygons (i.e., triangles) which are outside the viewing area and “clips” the polygons, which are partly inside and partly outside the viewing area. These clipped polygons will correspond to the portion of the polygon inside the viewing area with new edge(s) corresponding to the edge(s) of the viewing area. The polygon vertices are then transmitted to the next stage in coordinates corresponding to the viewing screen (in X, Y coordinates) with an associated depth for each vertex (the Z coordinate). In a typical system, the lighting model is next applied taking into account the light sources. The polygons with their color values are then transmitted to a rasterizer.

For each polygon, the rasterizer determines which pixels are positioned in the polygon and attempts to write the associated color values and depth (Z value) into frame buffer cover. The rasterizer compares the depth (Z value) for the polygon being processed with the depth value of a pixel, which may already be written into the frame buffer. If the depth value of the new polygon pixel is smaller, indicating that it is in front of the polygon already written into the frame buffer, then its value will replace the value in the frame buffer because the new polygon will obscure the polygon previously processed and written into the frame buffer. This process is repeated until all of the polygons have been rasterized. At that point, a video controller displays the contents of a frame buffer on a display one scan line at a time in raster order.

With this general background provided, reference is now made to FIG. 1, which shows a functional flow diagram of certain components within a graphics pipeline in a computer graphics system. It will be appreciated that components within graphics pipelines may vary among different systems, and may be illustrated in a variety of ways. As is known, a host computer 10 (or a graphics API running on a host computer) may generate a command list through a command stream processor 12. The command list comprises a series of graphics commands and data for rendering an “environment” on a graphics display. Components within the graphics pipeline may operate on the data and commands within the command list to render a screen in a graphics display.

In this regard, a parser 14 may receive commands from the command stream processor 12 and “parse” through the data to interpret commands and pass data defining graphics primitives along (or into) the graphics pipeline. In this regard, graphics primitives may be defined by location data (e.g., X, Y, Z, and W coordinates) as well as lighting and texture information. All of this information, for each primitive, may be retrieved by the parser 14 from the command stream processor 12, and passed to a vertex shader 16. As is known, the vertex shader 16 may perform various transformations on the graphics data received from the command list. In this regard, the data may be transformed from World coordinates into Model View coordinates, into Projection coordinates, and ultimately into Screen coordinates. The functional processing performed by the vertex shader 16 is known and need not be described further herein. Thereafter, the graphics data may be passed onto rasterizer 18, which operates as summarized above.

Thereafter, a Z-test 20 is performed on each pixel within the primitive. As is known, comparing a current Z-value (i.e., a Z-value for a given pixel of the current primitive) with a stored Z-value for the corresponding pixel location performs a Z-test. The stored Z-value provides the depth value for a previously rendered primitive for a given pixel location. If the current Z-value indicates a depth that is closer to the viewer's eye than the stored Z-value, then the current Z-value will replace the stored Z-value and the current graphic information (i.e., color) will replace the color information in the corresponding frame buffer pixel location (as determined by the pixel shader 22). If the current Z-value is not closer to the current viewpoint than the stored Z-value, then neither the frame buffer nor Z-buffer contents need to be replaced, as a previously rendered pixel will be deemed to be in front of the current pixel. For pixels within primitives that are rendered and determined to be closer to the viewpoint than previously-stored pixels, information relating to the primitive is passed on to the pixel shader 22, which determines color information for each of the pixels within the primitive that are determined to be closer to the current viewpoint.

Optimizing the performance of a graphics pipeline can require information relating to the source of pipeline inefficiencies. The complexity and magnitude of graphics data in a pipeline suggests that pipeline inefficiencies, delays, and bottlenecks can significantly compromise the performance of the pipeline. In this regard, identifying sources of aforementioned data flow or processing problems is beneficial.

One technique for identifying pipeline performance problems is include counters at predesignated points along the pipeline. The counters can be utilized to count, for example, cycles or data flow. In this manner pipeline performance can be monitored as data progresses through the pipeline. This approach, however, realizes, limited utility because the use of a realistic number of counters will merely identify a general location in the pipeline that is suffering from performance issues and frequently not provide enough information to permit a reliable identification of the source of the delay or inefficiency.

Another approach to monitoring pipeline performance is by placing multiple counters within each of the processing blocks of the pipeline. To provide an adequate amount of data, this approach requires a large number of counters, which can be prohibitive in terms of cost and system resources such as space, power, and processor bandwidth. Further, where the monitoring data is transmitted over the general data bus, system bandwidth is consumed, compromising system performance in some cases. Additionally, the multiple counters within each of the pipeline processing blocks will generate data that becomes excessively large and can result in an undesirable taxation on other system resources.

In practice, the use of counters between pipeline stages does not provide enough data to evaluate the performance of a pipeline at a meaningful level and the use of a large number of counters placed in the multiple processing blocks of a pipeline results in undesirable cost, resource, and performance effects. Thus, a heretofore-unaddressed need exists in the industry to address the aforementioned deficiencies and inadequacies.

### SUMMARY

Embodiments of the present disclosure provide systems and methods for monitoring performance in a graphics pipeline. Briefly described one embodiment of the system, among others, can be implemented as a system for monitoring the performance in a computer graphics processor having a plurality of pipeline processing blocks in a graphics pipeline. An exemplary system includes: performance monitoring logic, configured to gather data corresponding to graphics pipeline performance; a plurality of counting logic blocks, located within the performance monitoring logic; a plurality of logical counters, located in each of the plurality of pipeline processing blocks, configured to transmit a plurality of count signals to the performance monitoring logic; a plurality of counter configuration registers, configured to map a portion of the plurality of logical counters to the plurality of counting logic blocks; and a command processor configured to provide a plurality of commands to the performance monitoring logic.

Embodiments of the present disclosure can also be viewed as providing methods for performance monitoring in a computer graphics processor having a plurality of processing blocks. In this regard, one embodiment of such a method, among others, can be broadly summarized by the following steps: selecting one of a plurality of monitoring modes; grouping a portion of a plurality of logical counters corresponding to the one of the plurality of monitoring modes; configuring the portion of the plurality of logical counters, corresponding to a plurality of physical counters; sending a counting signal request within one of the plurality of processing blocks corresponding to the portion of the plurality of logical counters; receiving a counting signal at the plurality of physical counters from at least one of the plurality of logical counters; accumulating a plurality of counter values corresponding to the plurality of physical counters; and analyzing the plurality of counter values.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram illustrating a graphics pipeline as is known in the prior art.

FIG. 2 is a block diagram illustrating an embodiment of graphics pipeline having a system for monitoring performance in a computer graphics processor.

FIG. 3 is a block diagram illustrating an embodiment of a data bus configuration utilized in a system for monitoring performance in a computer graphics processor.

FIG. 4 is a block diagram illustrating an embodiment of a system for monitoring performance in a computer graphics processor.

FIG. 5 is a block diagram of an embodiment of a state diagram illustrating performance monitoring disclosed in the systems and methods herein.

FIG. 6 is a block diagram illustrating an embodiment of processing block counter control logic interfaced with a performance monitor.

FIG. 7 is a table illustrating an embodiment of operational codes for a central performance monitor.

FIG. 8 is a block diagram illustrating an exemplary method for performance monitoring in a computer graphics processor.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

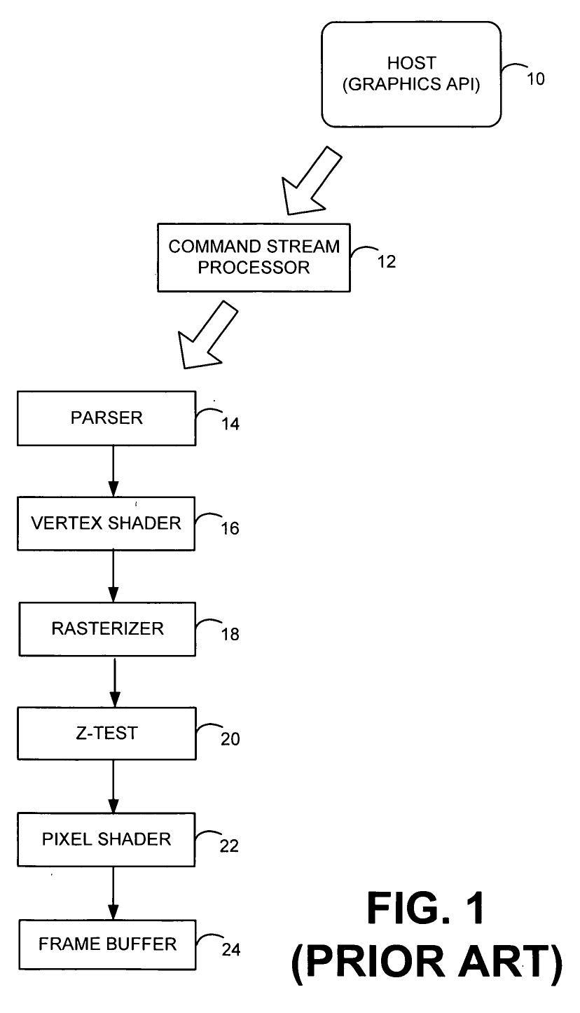

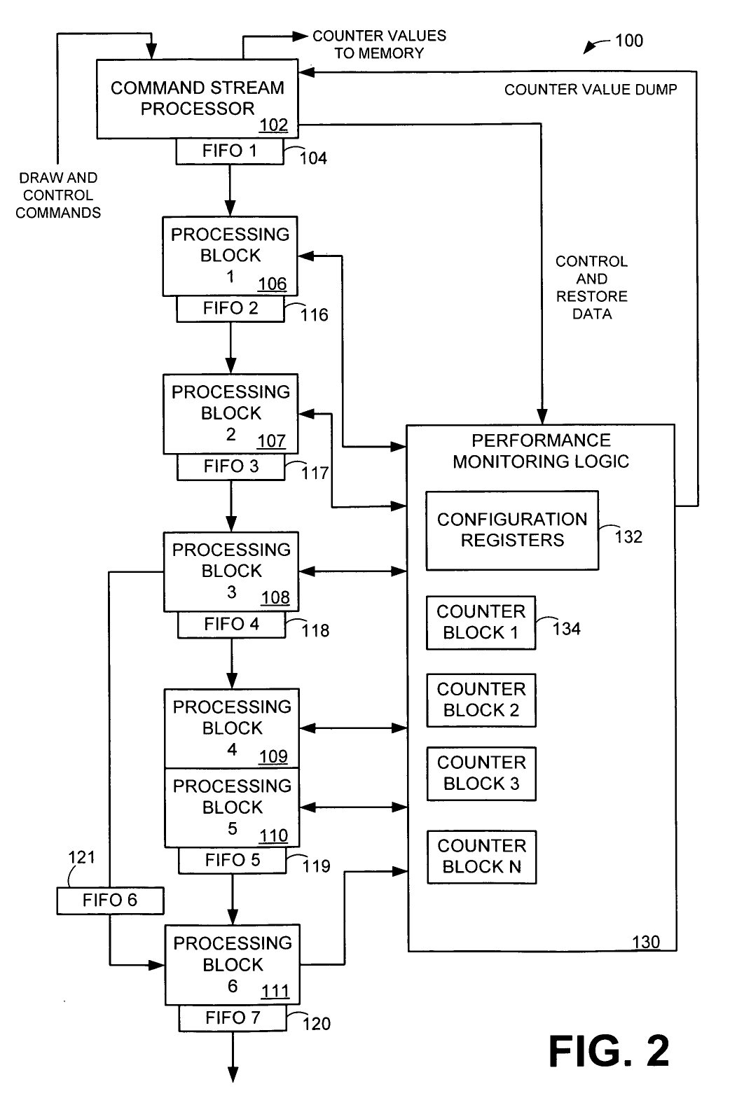

Reference is made to FIG. 2, which is a block diagram illustrating an embodiment of a graphics pipeline having a system for monitoring performance in a computer graphics processor. As discussed above regarding FIG. 1, the command stream processor 102 transmits commands and data to the pipeline for subsequent processing in processing blocks 106-111. The command stream processor 102 receives draw and control commands from the host processor (not shown). The command stream processor 102 includes FIFO 1 104, which is a first-in first-out register configured to manage the command and data flow from the command stream processor 102. Similarly, processing block 1 106 includes FIFO 2 116 for managing the data between processing block 1 106 and processing block 2 107. The processing blocks 106-111 can include any combination of parsers, vertex shaders, rasterizers, z-test processors, pixel shaders, and texture processors, among others. Performance monitoring logic 130 is configured to receive control and store data from the command stream processor 102. The performance monitoring logic 130 can also be referred to as a central performance monitor (CPM). The control and restore data can include the performance monitoring mode and request and clear performance data as needed. The performance monitoring logic 130 includes counter blocks 134. Counter blocks 134 are configured to receive a signal and accumulate and store counter data. In some embodiments, the signal that is received is a counting signal generated by logical counters within each of the processing blocks 106-111. In contrast, the logical counters are configured to generate counting signals, which are an output that can correspond to a system clock cycle for some duration determined by a condition or event. For example, where a single logical counter is configured to count for the duration of a designated system condition and that condition exists for one thousand clock cycles, a counter block that is mapped to receive the counting signal generated by that logical counter will accumulate a value corresponding to the one thousand cycle duration of the condition. Each of the processing blocks 106-111 includes multiple logical counters for measuring processing performance and data flow issues within the processing block. Multiple logical counters can be two or more individual logical counters. The counter blocks 134 are physical counters or registers that accumulate and store counter data, whereas the logical counters merely generate a counting signal, which can then be received by a designated physical counter block 134. The configuration registers 132 located within the performance monitoring logic 130 can determine which of the counting signals are received by the counter blocks 134 by mapping specific counting signals to specific counter blocks 134. For example, when the performance monitoring logic is operating in a global monitoring mode, a small number of counting signals will be received from each of the processing blocks 106-111. By monitoring a few points across the entire pipeline, the global mode permits the identification of general areas or processing blocks where undesirable performance characteristics are exhibited. Alternatively, the configuration registers 132 can be used to map multiple counters from one or two processing blocks 106, 107, for example, in order to determine a precise location of a data flow or process inefficiency. In addition to defining the monitoring mode, the command stream processor 102 can also signal the performance monitoring logic 130 to provide a counter value dump, which results in the counter values being transmitted to a memory location, also identified by the command stream processor 102.

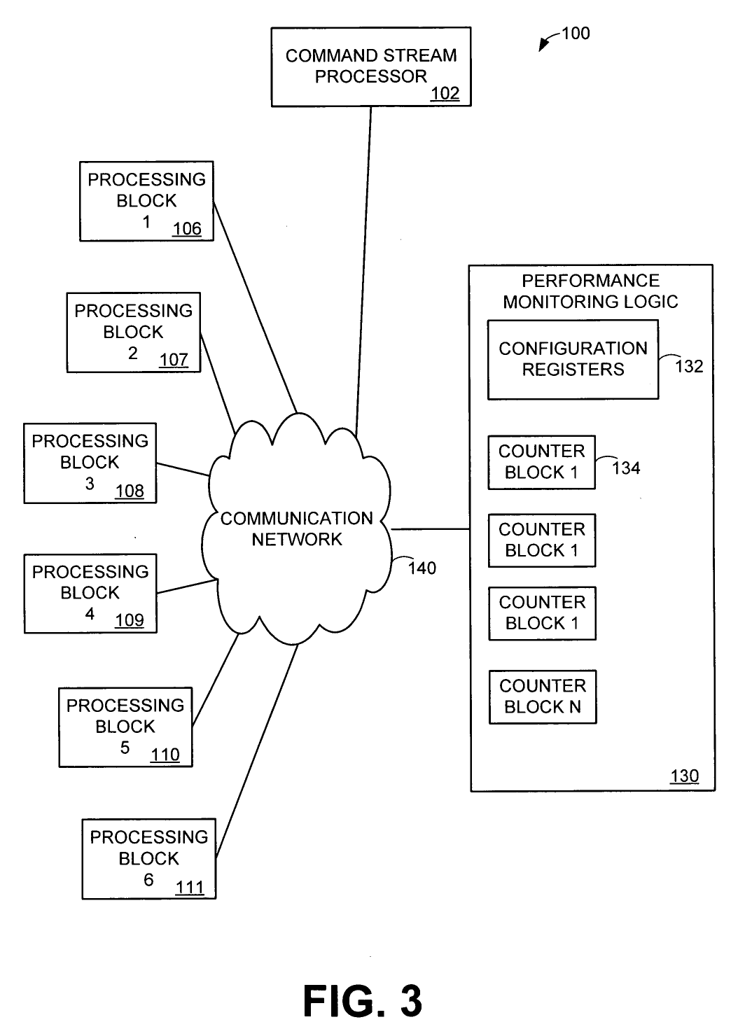

Reference is now made to FIG. 3, which is a block diagram illustrating an embodiment of a data bus configuration utilized in a system for monitoring performance in a computer graphics processor. The graphics pipeline includes the command stream processor 102 and processing blocks 1-6 106-111 all communicatively coupled, in the illustrated embodiment, to a communication network 140, configured to transmit data corresponding to graphics pipeline performance monitoring. Also connected to the communication network 140 is the performance monitoring logic 130, which includes the configuration registers 132 and the counter blocks 134. The communication network 140 can be configured to transmit the control and query instructions from the command stream processor 102 to the performance monitoring logic 130. Additionally, the communication network 140 can be configured to communicate the counter values requested by the command stream processor 102. The communication network 140 also transmits configuration information from performance monitoring logic 130 to the processing blocks 106-111 to identify which of the multiple logical counters are designed to generate counting signals. Additionally, the counting signals generated within the processing blocks 106-111 are transmitted over the communication network 140 to the performance monitoring logic 130. The counting signals are mapped by the configuration registers 132 to specific counter blocks 134. When implemented as a dedicated bus, the use of the communication network 140 prevents the performance monitoring processes from interfering with or otherwise adversely impacting the graphics processing operations within the pipeline. Of course, embodiments may be implemented using shared busses within the scope and spirit of this disclosure. Other embodiments of the communication network 140 can include a bus containing several segments with bus arbiters that work on a cyclical basis and provide access for the processing blocks 106-111 and the command stream processor 102. Additionally, the simple logic counters in the processing blocks 106-111 can include accumulation logic to accommodate possible delays in bus access. Each of the logical signals can utilize one or more wires on a bus. For example, some embodiments may include an interface between the processing blocks 106-111 and the performance monitoring logic 130 that utilizes thirty-two or more bits.

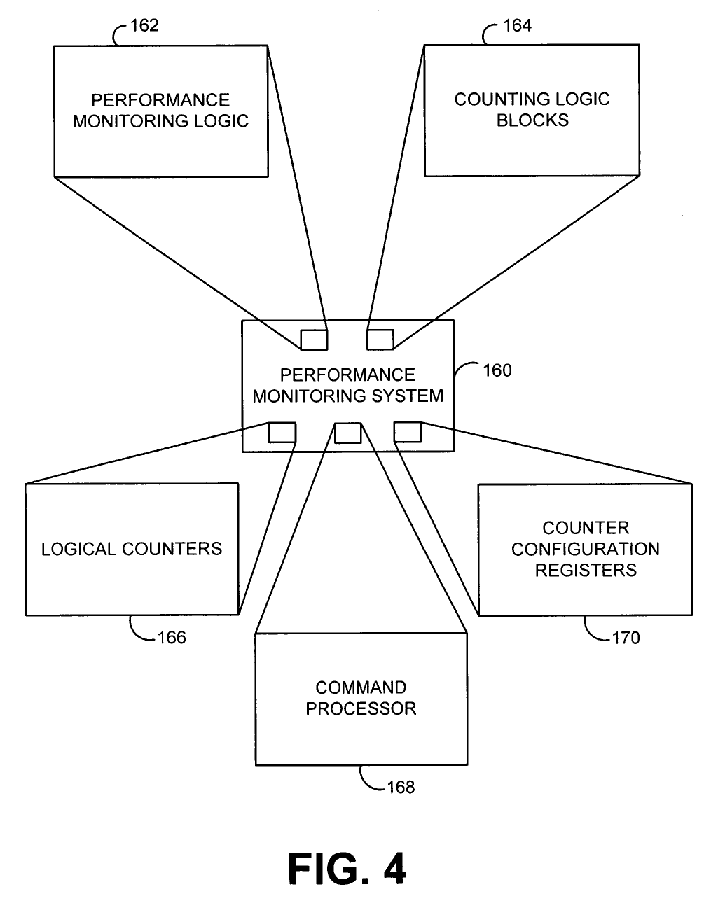

Reference is now made to FIG. 4, which is a block diagram illustrating an embodiment of a system for monitoring performance in a computer graphics processor. A performance monitoring system 160 includes performance monitoring logic 162. The performance monitoring logic 162 serves to manage the overall performance monitoring process. For example, the performance monitoring logic 162 can be used to decode the operational codes transmitted by the command stream processor 168 to determine, for example, which of the monitoring modes is selected by the host processor. The performance monitoring logic 162 can also be used to control the counter configuration registers 170, which can be used to provide the mapping between the logical counters 166 and the counting logic blocks 164. The logical counters 166 are configured within multiple processing blocks that constitute the graphics pipeline and provide a counting signal that can be mapped to the counting logic blocks 164. The monitoring mode would determine which portion of the logical counters 166 are mapped to the counting logic blocks 164. The mapping between the logical counters 166 and the counting logic blocks 164 is performed by the counter configuration registers 170.

The command stream processor 168 also provides a dump command to the performance monitoring logic 162 that can include a memory or register address for the counter values to be written. Additionally, the command stream processor 168 can provide a reset command to the performance monitoring logic 162. A reset command can be utilized to cause the counter values to be reset from any previous performance monitoring operations. In this manner, counter values from previous performance monitoring operations will not affect subsequent performance monitoring operations. The monitoring modes can be, for example, either global or local. Additionally, the global and local modes can be further resolved into multiple sub-modes, depending on which performance properties are to be analyzed. In the global modes, one or two logical counters 166 are selected from each of the processing blocks in the graphics pipeline. In contrast, in the local modes, many logical counters are selected within one or two of the processing blocks to provide high resolution data corresponding to a selected portion of the graphics pipeline.

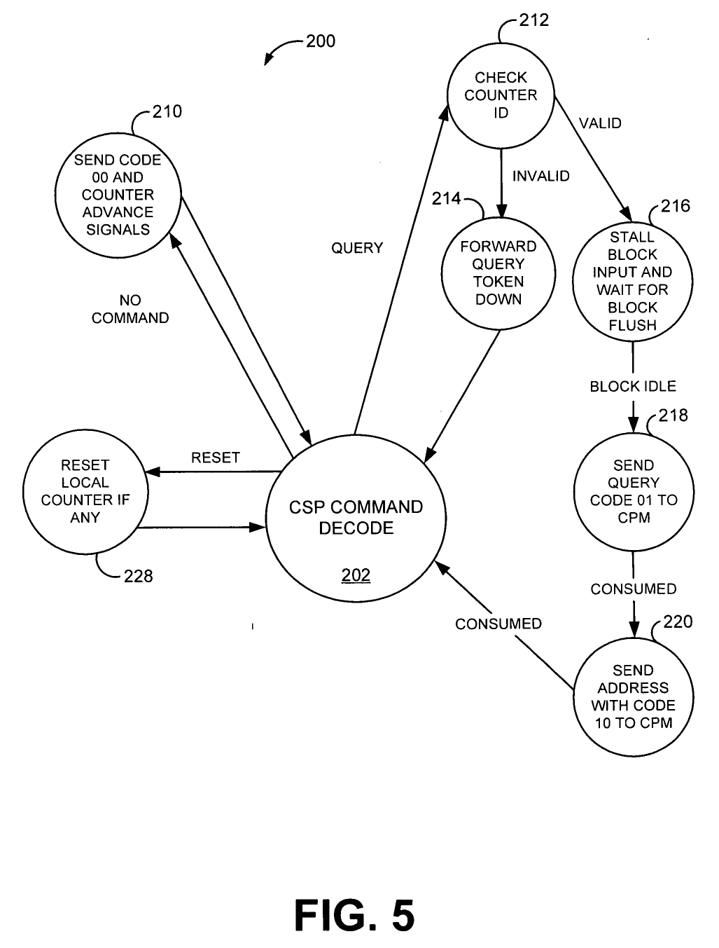

Reference is now made to FIG. 5, which is a block diagram of an embodiment of a state diagram illustrating performance monitoring as disclosed in the systems and methods herein. The command transmitted by the command stream processor (CSP) is decoded in block 202. Where the command is a query command the counter ID is checked in block 212. A query command can be utilized to cause the results of a completed or an ongoing performance monitoring operation to be reported or written to a memory location. If the counter ID is invalid then a query token is forwarded in block 214 and the query sequence is complete. Where the counter ID is checked as valid, further input to the processing block is stalled until the processing block is flushed in block 216. Once the processing block is flushed, the query opcode with control code 01 is sent to the central performance monitor (CPM) in block 218 followed by the address with control code 10 to the central performance monitor in block 220. Where the command is a dump register command, the processing block is stalled until the processing block is flushed (not shown). As soon as the processing block is free, a counter value is attached to the dump token and sent. Where the command is a reset command, the corresponding local counter, if any, is reset in block 228. Where the command is a no command, control code 00 and counter advancing signals are sent in block 210.

Some embodiments of performance monitoring disclosed herein generally include two primary commands. The configuration command from the command stream processor sets a configuration register and related logic prior to performance monitoring. In this manner, the configuration command is utilized to provide the configuration information corresponding to a requisite state for a particular performance monitoring mode. Once the state is established per the configuration command, the status of the logic and hardware will remain unchanged until a subsequent different configuration command is sent. The configuration command, for example, selects an operation mode for the performance monitor, which can then communicate to each processing block via a configuration bus. Since the configuration data is not particularly data-intensive, the configuration bus can be on the range of, for example, four bits. The query command from the command stream processor triggers the gathering of one port of counter values from the performance monitor during the performance monitoring operation. This command can be used multiple times to complete the counter value gathering of the selected monitoring mode.

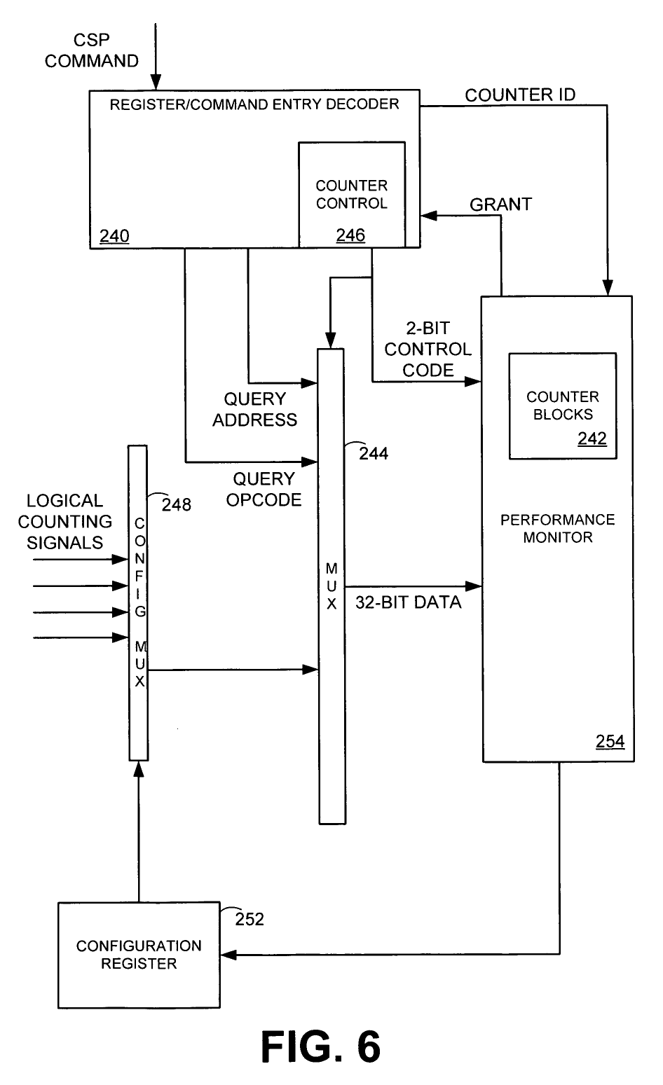

Reference is now made to FIG. 6, which is a block diagram illustrating an embodiment of processing block counter control logic interfaced with a performance monitor. A command stream processor command is received at the register/command entry block 240. The register/command entry decoder block 240 includes a counter control block 246, configured to generate a 2-bit control code to both the MUX 244 and the performance monitor 254. The 2-bit control code can be utilized by the MUX 244 to select counting signals that can are pre-selected from all logical counting signals by the configuration register 252. The 2-bit control signal can also be utilized to select the query opcode or the query dump address for transmission to the performance monitor 254. The MUX 244 transmits, for example, a 32-bit data stream to the performance monitor 254. The 32-bit data stream can include a query opcode, a query address, selected logical counting signals or a combination thereof. The performance monitor 254 also transmits configuration data to the configuration register 252, which controls the configuration MUX 248. The configuration MUX 248 is utilized to select which of the logical counting signals is transmitted to the MUX 244. The performance monitor 254 includes counter blocks 242, which can be mapped to the selected logical counting signals via the configuration MUX 248 and the MUX 244. The counter blocks 242 are the multiple counters that are configured to receive the counting signals generated within the processing blocks (not shown). A query address and a query opcode are transmitted from the register/command entry decoder block 240 to the MUX 244 for potential transmission to the performance monitor 254.

Additionally, the counter blocks 242 receive two control bits from the register/command entry decoder block 240 that can be utilized to start and stop specific counter operations. A counter ID value is transmitted from the register/command entry decoder block 240 to the performance monitor 254, which tells the performance monitor which logical counter is to be queried and how many contiguous counters are to be queried. The configuration MUX 248 receives the logical counting signal, which is further transmitted to the MUX 244. The 32-bit data transmitted from a MUX 244 can be either counting signals to the counter blocks 242 or a query opcode or query address to the performance monitor 254 to finish the query command by sharing the 32-bit bus. Using the 32-bit bus in this manner serves to reduce the hardware complexity. In this manner, the logical counting signals that originate in the processing blocks are mapped to specific physical counter blocks 242. Also in this manner, a query command is transmitted over the shared 32-bit bus to the performance monitor. The query command signals the performance monitor to read the counter values from physical counters and write the corresponding values to memory as defined by the query address. The query command can include, for example, logical counter identification data, quantity of physical counters, a receiving address, and an operational code for triggering a counter data dump. In alternative embodiments, the processing blocks (not shown) and the counter blocks can be each divided into corresponding groups such that each group of counter blocks can receive counting signals from a corresponding group of processing blocks.

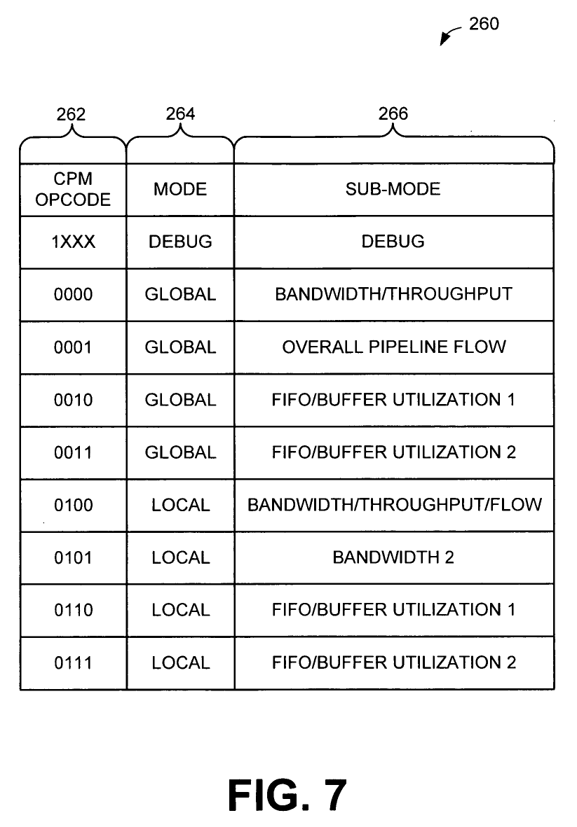

Reference is now made to FIG. 7, which is a table illustrating an embodiment of operational codes for a central performance monitor. An exemplary embodiment of an operational code for the central performance monitor is illustrated in the values contained in the central performance monitor (CPM) operational code (OPCODE) column 262. The CPM operational code of some embodiments is a four-bit code where the first bit is used to identify whether the central performance monitor is in debug mode, the operation of which is not presented in detail herein, or in one of the multiple monitoring modes. For instance, a value of one in the most significant bit is utilized when the CPM is in debug mode. Where the most significant bit is zero, the CPM operates in one of the multiple monitoring modes. The second bit in the four-bit CPM operational code designates whether the general mode is global or local. Where the second bit is a zero, the monitoring mode is global and where the second bit is a one the monitoring mode is local.

The global mode is generally utilized to analyze overall graphics pipeline performance statistics and status to determine the general locations for potential bottlenecks, delays, and inefficiencies. The global mode can include several sub-modes as illustrated in the sub-mode column 266 that determine which properties of the pipeline are to be analyzed. In each global sub-mode a few logical counters can be selected from each processing block up to the quantity of physical counters contained in the central performance monitor counter pool. The global sub-modes include a bandwidth sub-mode, a pipe flow status sub-mode, and a FIFO status sub-mode. A bandwidth sub-mode, for example, monitors all data traffic over a pipeline bus internal to the graphics processor or entering or exiting the graphics processor from or to external sources. The monitored content can include, but is not limited to indices, vertices, primitives, pixels, textures, Z-data, color attributes, color data, mask data, and any other data generated internal to the pipeline stages. A FIFO status sub-mode monitors the status of all of the key FIFO's and buffers to determine which of these components is being under or over utilized. Depending on the number of FIFO's and buffers in the pipeline, this sub-mode may utilize more than one configuration. A pipe flow status sub-mode can be utilized to monitor the stall times at different points of the pipeline to determine where stalling, executing, or back pressuring is occurring.

As in the global mode, the local mode can also include the same or similar sub-modes for determining different performance properties of specific global areas in the pipeline. Unlike the global mode, the local mode utilizes logical counters from very few processing blocks. In this manner, many logical counters can be monitored at the same time within the selected processing blocks such that the processing block performance can be analyzed in significant detail. By performing multiple runs in different modes, full pipeline performance issues can be determined through the combined use of global and local resolution modes to monitor the status of the entire pipeline and/or particular processing blocks. The type of data monitored by the pipeline includes, but is not limited to, bus traffic bandwidth, pipe stage working cycles, pipe stage stalled cycles by other modules, pipe stage stalling cycles to other modules, and numerous FIFO data, including the number of cycles full, the number of cycles empty, and the number of cycles when the FIFO occupied below and beyond one or more thresholds. When the performance monitor receives the operational code (configuration mode) from the command stream processor, the performance monitor transmits a configuration code to the processing blocks.

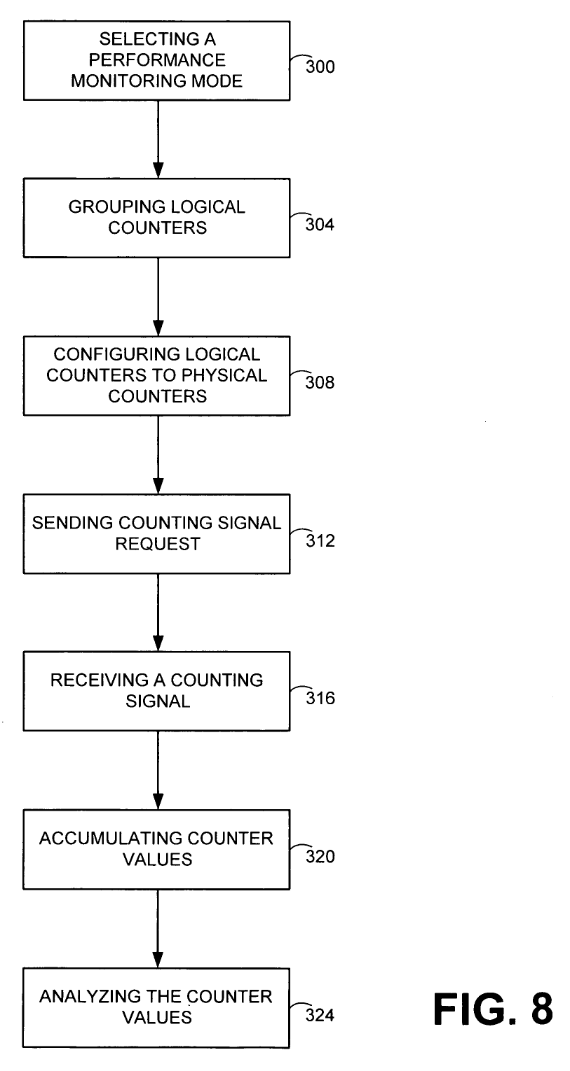

Reference is now made to FIG. 8, which is a block diagram illustrating an exemplary method for performance monitoring in a computer graphics processor. A performance monitoring mode is selected in block 300. The performance monitoring mode can either be selected as a global mode or a local mode where each of the global and local modes further includes sub-modes, which are configured to identify different performance properties of the pipeline. A command processor block transmits a performance monitoring configuration command configured to define the selection of a monitoring mode. Based on the selection of the monitoring mode, logical counters are grouped in block 304 for generating counter signals from one or more of the processing blocks in the pipeline. The logical counters within the processing blocks can be utilized to generate counter signals that can be used to increment actual counters located in a central module. The logical counters are grouped according to the specific monitoring mode. For example, a small number of counters from each processing block in the pipeline can be selected in one of the global monitoring modes, whereas a larger number of counters can be selected from one or a few of the processing blocks when performing local monitoring.

The logical counters are then configured to physical counters in block 308. The configuring can be performed using, for example, mapping techniques, which can utilize one or more configuration registers. In this manner, the counting signals generated by the logical counters are received by physical counters based on any number of different logical counter configurations and groupings that depend on the different performance monitoring modes. A counting signal request is sent within the processing blocks to the selected logical counters in block 312. The counting signal request identifies which of the logical counters in a processing block is designated to provide counting signals. The logical counters transmit the requested counting signals, which are received by the physical counters in counter blocks in block 316. The counting signals can be sent over a dedicated bus from the processing blocks. The physical counters accumulate the counter values in block 320 corresponding to the counting signals generated by the logical counters. A query command can be configured to request a counter data dump to a designated memory address. The counter values are queried and analyzed in block 324 to determine pipeline statistics such as bus traffic bandwidth, pipe stage working cycles, pipe stage stalled cycles by other processing blocks, pipe stage stalling cycles to other processing blocks and numerous FIFO statistics including number of cycles full, number of cycles empty and number of cycles occupied above or below a designated threshold. A global performance monitoring mode can be utilized in selected sub-modes to identify specific attributes and properties of the pipeline and to identify general locations in the pipeline where stalls, bottlenecks, and inefficiencies may be present. The local performance monitoring mode can be utilized in selected sub-modes to identify the locations of stalls or inefficiencies within one or more selected processing blocks in the pipeline. In this manner, selected processing blocks can be analyzed in significant detail, as indicated by the data generated in a global performance monitoring mode.

In view of the above, the disclosure herein includes improvements over the prior art that improve the effectiveness of performance monitoring. These improvements include, for example, the use of multiple monitoring modes using a relatively small number of physical counters mapped to logical counters within the processing blocks. This is in contrast with placing many physical counters within or between each of the processing blocks at each point of monitoring. The disclosure thus provides a flexible and diverse performance monitor that requires very few additional hardware resources and results in minimal impact on system performance while monitoring. Further, the global and local modes in combination provide an effective performance monitoring function that is suited to the serial nature of a graphics pipeline by allowing the analysis of the pipeline at differing levels of abstraction.

Embodiments of the present disclosure can be implemented in hardware, software, firmware, or a combination thereof. Some embodiments can be implemented in software or firmware that is stored in a memory and that is executed by a suitable instruction execution system. If implemented in hardware, an alternative embodiment can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of an embodiment of the present disclosure in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure, particularly, any illustrated embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

At least the following is claimed:

1. A method for performance monitoring in a computer graphics processor having a plurality of processing blocks, comprising:
selecting one of a plurality of monitoring modes;
grouping a portion of a plurality of logical counters corresponding to the one of the plurality of monitoring modes;
configuring the portion of the plurality of logical counters, corresponding to a plurality of physical counters;
sending a counting signal request within one of the plurality of processing blocks corresponding to the portion of the plurality of logical counters;
receiving a counting signal at the plurality of physical counters from at least one of the plurality of logical counters;
accumulating a plurality of counter values corresponding to the plurality of physical counters; and
analyzing the plurality of counter values.

2. The method of claim 1, further comprising defining a query command configured to request counter data.

3. The method of claim 1, wherein one of the plurality of monitoring modes comprises a global mode and wherein the portion of the plurality of logical counters in each of the plurality of processing blocks is accessed.

4. The method of claim 3, wherein the grouping further comprises assigning the portion of the plurality of logical counters from each of the plurality of processing blocks if the mode is global.

5. The method of claim 3, further comprising selecting one global sub-mode from a plurality of global sub-modes.

6. The method of claim 5, wherein the global sub-mode is selected from the group consisting of:
a bandwidth sub-mode, configured to monitor major traffic bandwidth in the plurality of processing blocks;
a FIFO status sub-mode, configured to monitor a plurality of FIFO registers; and
a pipe flow status sub-mode, configured to determine locations where data is delayed.

7. The method of claim 6, where the bandwidth sub-mode comprises monitoring a total number of a plurality of data values per unit time.

8. The method of claim 7, wherein the plurality of data values are selected from the group consisting of: vertices, indices, primitives, color attributes, coordinate attributes, texture attributes, pixels, pixel fragments, Z-data, stencil data, and color data.

9. The method of claim 6, wherein a plurality of FIFO data values are selected from the group including: number of cycles full, number of cycles empty, number of cycles greater than a first predefined threshold, and number of cycles less than a second predefined threshold.

10. The method of claim 6, further comprising utilizing the pipe flow status sub-mode by determining a number of cycles that one of the plurality of processing blocks is stalled while waiting for a subsequent one of the plurality of processing blocks becomes available.

11. The method of claim 6, further comprising utilizing the pipe flow status sub-mode by determining a number of cycles that one of the plurality of processing blocks is stalled while waiting for a data from another of the plurality of processing blocks.

12. The method of claim 6, further comprising utilizing the pipe flow status sub-mode by determining a number of cycles that one of the plurality of processing blocks is stalling another of the plurality of processing blocks.

13. The method of claim 1, wherein one of the plurality of monitoring modes comprises a local mode and wherein the portion of the plurality of logical counters in one of the plurality of processing blocks is accessed.

14. The method of claim 13, wherein the grouping further comprises assigning the portion of the plurality of logical counters from one of the plurality of processing blocks if the mode is local.

15. The method of claim 1, wherein the sending further comprises identifying which of the plurality of logical counters in the one of the plurality of processing blocks provide a counting signal.

16. The method of claim 1, further comprising:
receiving, from a command processor block, a performance monitoring configuration command; and
selecting one of the plurality of monitoring modes based on the performance monitoring configuration command.

17. The method of claim 1, further comprising receiving, into a portion of the plurality of physical counters, a plurality of counting signals over a dedicated bus from a portion of the plurality of processing blocks.

18. A system for monitoring the performance in a computer graphics processor having a plurality of pipeline processing blocks in a graphics pipeline, comprising:
performance monitoring logic, configured to gather data corresponding to graphics pipeline performance;
a plurality of counting logic blocks, located within the performance monitoring logic;
a plurality of logical counters, located in each of the plurality of pipeline processing blocks, configured to transmit a plurality of count signals to the performance monitoring logic;
a plurality of counter configuration registers, configured to map a portion of the plurality of logical counters to the plurality of counting logic blocks; and
a command processor configured to provide a plurality of commands to the performance monitoring logic.

19. The system of claim 18, wherein one of the plurality of commands is selected from the group consisting of:
a configuration command configured to determine a mode; and
a query command configured to request counter data.

20. The system of claim 19, wherein the configuration command comprises an operational code, configured to define one of a plurality of monitoring modes.

21. The system of claim 20, wherein one of the plurality of monitoring modes comprises a global mode, configured to access counter data from each of the plurality of pipeline processing blocks.

22. The system of claim 21, wherein the global mode comprises a plurality of global sub-modes.

23. The system of claim 22, wherein one of the plurality of global sub-modes comprises a bandwidth sub-mode, configured to monitor data traffic in each of the plurality of pipeline processing blocks.

24. The system of claim 23, wherein the data traffic is selected from the group consisting of: vertices, triangles, lines, points, coordinates, color attributes, texture coordinates, pixels, pixel fragments, Z-data, stencil data, and color data.

25. The system of claim 22, wherein one of the plurality of global sub-modes comprises a FIFO status sub-mode, configured to monitor FIFO data corresponding to a plurality of FIFO registers.

26. The system of claim 25, wherein the FIFO data is selected from the group comprising: number of cycles full, number of cycles empty, number of cycles greater than a first predefined threshold, and number of cycles less than a second predefined threshold.

27. The system of claim 22, wherein one of the plurality of global sub-modes comprises a pipe flow status sub-mode, configured to determine locations where data is delayed.

28. The system of claim 27, wherein the pipe flow status sub-mode comprises determining the number of cycles a stall occurs in one of the plurality of processing blocks.

29. The system of claim 28, wherein the stall comprises an event selected from the group consisting of:
waiting for data from a process performed by a previous block; and
waiting for a subsequent block to be available for processing.

30. The system of claim 28, wherein the stall comprises one of the plurality of processing blocks causing another one of the plurality of processing blocks to wait.

31. The system of claim 18, wherein the query command comprises data selected from the group consisting of:
logical counter identification data;
quantity of the plurality of physical counters;
an address configured to receive counter data; and
an opcode configured to trigger a counter data dump.

32. The system of claim 18, further comprising a dedicated data bus interconnecting the performance monitoring logic and each of the plurality of pipeline processing blocks.

33. The system of claim 18, wherein the performance monitoring logic comprises a means for retrieving counter data from the plurality of counting logic blocks.

34. The system of claim 18, wherein the performance monitoring logic writes counted data to a memory address.

35. The system of claim 18, further comprising:
a plurality of groups of processing blocks;
a plurality of groups of counting logic blocks; and
wherein each of the plurality of counting logic blocks receives a portion of the plurality of counting signals from a corresponding one of the plurality of processing blocks.

36. A system for monitoring performance in a computer graphics processor having a plurality of pipeline processing blocks, comprising:
a plurality of count signals, generated by the plurality of pipeline blocks; and
a plurality of counting logic blocks, configured to receive a portion of the plurality of count signals, wherein the portion is determined by a monitoring mode.
